(19) United States
(12) Patent Application Publication
(10) Pub. No.: US 2019/0147164 A1
(43) Pub. Date: May 16, 2019

(54) NOVEL METHODOLOGY, PROCESS AND PROGRAM FOR THE REPAIR OF DISABLED, BADLY INFECTED OR SLOW WINDOWS COMPUTERS

(71) Applicants: Robert P. Wing, Broomfield, CO (US); Harvey Lawton, Cumming, GA (US)

(72) Inventors: Robert P. Wing, Broomfield, CO (US); Harvey Lawton, Cumming, GA (US)

(21) Appl. No.: 16/186,534

(22) Filed: Nov. 10, 2018

Related U.S. Application Data
(60) Provisional application No. 62/584,756, filed on Nov. 11, 2017.

(51) Int. Cl. G06F 21/56; G06F 21/57

(52) U.S. Cl. CPC G06F 21/568; G06F 21/57

(57) ABSTRACT

A method and software comprising two processes or steps into a simple automated program for end users enabling anyone to repair disabled, badly infected and slow computers. Step 1 is the Low Level Repair Process which uses its own boot environment to perform backup, restore and reset conditions to known good states as well as repair startup, boot, hardware, connectivity, hard drive, driver, Operating System, Software, file and component repairs. Step 2 is the Threat Removal and System Repair Process that incorporates a program to provide effective Threat(s) disabling and removal utilizing process and methods sequencing multiple software products and Tools in an automated manor that can run and control any Software or Tool providing flexibility to add or replace or change sequencing or frequency of same as Threats evolve.

### FIELD OF THE INVENTION

The present invention relates to a novel Process and Methods that thoroughly repair all facets of a disabled, badly infected or slow computer. More particularly a process that repairs boot and or startup, blue/black screens, missing files or components, hard drives, drivers, Operating Systems, internet/connectivity, slowness, software, hanging, boot loops, firmware corruption, BIOS setting change or corruption, and any other symptom or disabling problem here in after called “Repairs”” (single or plural and all encompassing). Additionally the Process performs Malware removal, Virus removal, corrupt process or service stoppage and removal or repair, Trojan removal, Worm removal, Rootkit removal, any existing or future security or operational intrusions, Ransomeware removal, Potentially Unwanted Program (PUP) removal, here in after referred to as “PUP removal””(single or plural and all encompassing). Removal of hooks or monitors that affects operation or passes information, stopping of browser redirection or marketing pop-ups, repair of browser corruption, removal of intrusive software or operational intrusions that interfere with the computers operation, remove of malicious code or operations, or any other intrusive mechanism that affects a computers operation. Here in after to be referred to as “Threats” (single or plural and all encompassing). In essence the ability to repair any issue hardware or software related that does not include component replacement.

### BACKGROUND

Threats and other as of yet known and unknown security vulnerabilities have started targeting and corrupting the start-up, boot, speed, connectivity and functionality of computers making them slow or inoperable. In order to repair these problems and thoroughly repair and clean the infected computers a multitude of programs and tools are necessary of various specialties which take technical expertise and Repair process knowledge to be able to run.

Recently, these Threats have become prolific on the internet affecting most computers with multiple intrusion types simultaneously. Facing multiple threat types, no single repair program, software, Tools, utility, executable, code, instruction or security scanner here in called “Tools” (single or plural and all encompassing) are effective in repairing today's intrusions. This necessitates the running of multiple Tool types in specific process steps and sequences. In addition, the skill set to repair and clean these machines and make them operable is above the skill set of most end users rendering these computers unusable and accelerating unnecessary disposal.

Additionally, the variety of necessary Tools and products to provide effective Repair is so varied that even professionals overlook important steps or sequences rendering the computer Improperly repaired and/or susceptible to return infection. Proper selection and sequencing of the various Tools are critical as some may need to be run before others. In many cases improper sequencing may cause subsequent Tools to lock up or not launch/run at all.

Also, In addition to the sequence in which an operation is performed there are various times that one or more Tools and or programs may need to be repeated to provide effective repairs. These repeated steps provide a logical sequence of attack designed to disable Threats lodged deep and repeatedly throughout the computers installed software, firmware, memory, BIOS, Operating System or control software and/or any of its components.

As a part of the Repairs Tools may need to be ran that remove, turn off or disable known or suspected executable (exe) files, processes, services, components or any other operations that have been added, corrupted or disabled by security intrusions, Threats, Code Modifications, or intrusive agent. Removing or rendering ineffective these known Threats enables the Tools they target to then be able to run and or execute. Thus by disabling the known Threats, other Tools and cleaners may run uninterrupted until completion. In addition, it should be noted that Threats can target the very programs and technologies that were developed to remove them.

Therefore, a need exists in the field for novel Process in combination with simple software program and Methodologies that enables average end users the ability to effect advanced computer repair on their own without advanced training. This comprises a flexible software program with simple user interface that is designed to be highly automated, variable, and easily adaptable based on emerging Threat technology. The program is designed to allow complete variability, can be configured to run third party software or Tools, change or vary methodologies, run any combination of code, instructions, executables, programs, commands or software and automate user interaction configurable in a short amount of time enabling ongoing and effective real time Repairs.

### BRIEF SUMMARY OF THE INVENTION

The present invention comprises a novel approach with three parts consisting of a Process that incorporates multiple software products and Tools in an automated and sequenced manor, Methodologies that utilize Operating System features and backups, stored information or settings, computer states or other settings saved to the hard disk to resolve system problems or restore conditions, and a Program that can automatically run and control any Software or Tool providing flexibility to add or replace or change sequencing or frequency of same as Threats evolve in the future. A software program comprising two processes or steps combined into a simple automated program for end users enabling anyone to repair disabled, badly infected and slow computers. Step 1 is the Low Lever Repair Process and Step 2 is the Threat Removal and System Repair Process utilized in combination they can provide total PC repair.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a flowchart of the Low Level Repair Process being performed in Step 1 to Repair low level functionality of the computer's hardware, its components, firmware, BIOS, software and operating or control system.

FIG. 2 depicts a flowchart of the Threat Removal and System Repair Process being performed in Step 2 to Repair and clean a computer of Threats and to restore settings, files, states, conditions, operating conditions or other variables that enable proper operation of a computer, its components, firmware, BIOS, software and/or operating or control software.

FIG. 3 depicts one embodiment of a program and/or software to Repair disabled, badly infected and slow computers. It incorporates the two Processes in FIGS. 1 and 2 into a redundant, flexible, and automated program that anyone can use.

FIG. 4 depicts one embodiment of a System Recovery Process program and/or algorithm that can be automatically launched should a user experience problems due to running of the software. Essentially the program resets the computer to a state where the computer was prior to Repairs being initiated.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of the techniques and steps are disclosed. Each of these has individual benefit and each can also be used in conjunction with one or more, or in some cases all, of the other disclosed techniques. It should be noted for all of the Figures included that the steps depicted may be interchanged or their position in the Process can be modified easily to match current and evolving Repair and/or Threat technologies. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

All claims incorporates a computer, workstation or PC (personal computer) comprised of a CPU/Computer for supporting a plurality of processing environments, a BIOS, Firmware, drivers or software for managing computer hardware and component control, memory supporting a plurality of data stores, a hard disk providing a plurality of data stores, an LCD or monitor to view inputs and outputs, an internet connection for connectivity to the world wide web, and an operating system or control program to provide control and platform for operating and executing programs and instructions. It is understood that stated configuration does not limit future evolution of CPU or Computer technology and/or software.

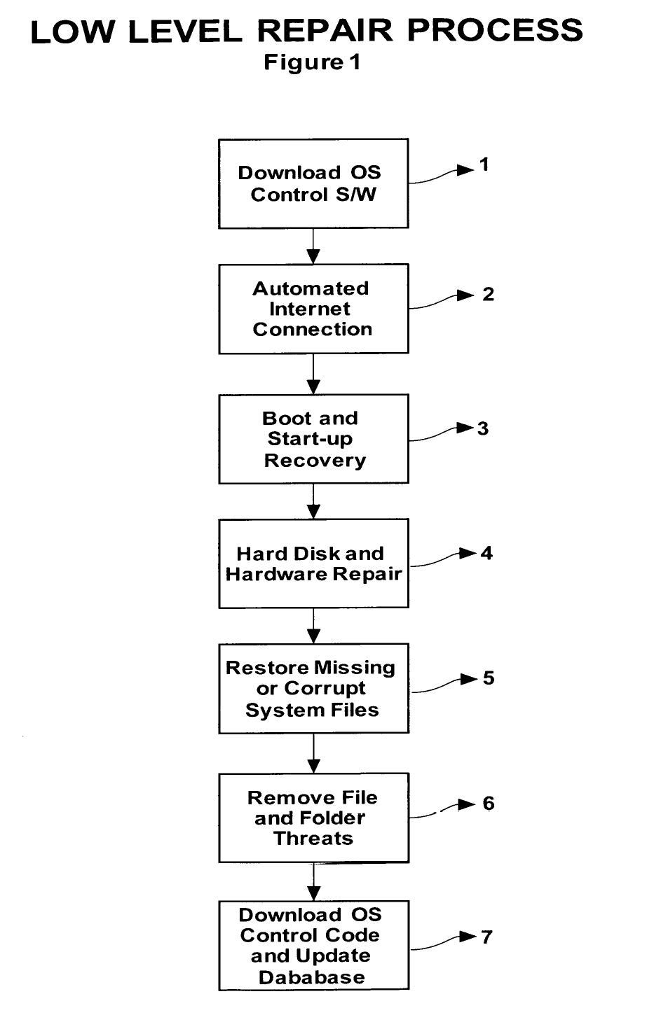

The present invention will now be described using the appended figures representing preferred embodiments. It should be acknowledged that the Process has specific steps and utilizes specific technology or Tools to perform sequenced and repetitive repairs designed to maximize the outcome. In some cases it may be determined a Tool may not need to be ran or may need to be ran multiple times to effect repairs. All steps in the Process can be modified, skipped, added to, removed or replaced, or enhanced based on current Threat technology or needs. FIG. 1 represents the embodiment of a low level Repair Process or Step 1 as represented in the current embodiment. This Process is compromised of its own independent operating system or control code allowing alternate start-up of the computer, workstation or PC enabling it to check and repair boot or start-up issues, automatically connect to the internet, check and repair hard disk and or other hardware or component issues, allow access to files, history and stored information of all types, allow user file access for backing up their data, restore missing or corrupt system settings and files, remove file and folder Threats and other Threats, and perform a controlled reboot into the operating systems safe or engineering mode. This mode usually reduces the number of instructions or options removing more taxing or onerous operations.

FIG. 1 (1) illustrates the downloading of an operating system or control software that will control the CPU independently and apart from the computers standard operating system located on its hard disk drive. This provides the program and or software with independent access to individual files or information on the computer allowing the Repair and removal of Threats that otherwise may be inaccessible.

FIG. 1 (2) illustrates the connecting of the computer to the internet using stored profiles and a reset/reload algorithm designed to provide maximum connectivity without user intervention.

FIG. 1 (3) illustrates the recovery of stored boot and start-up information, computer states, software and Operating System settings and or files, components or other stored information to repair non-booting and or non-starting computers. This algorithm uses a multitude of information, data and stored profiles on the disabled computer to recreate the last state that worked correctly and enable successful booting and start-up.

FIG. 1 (4) illustrates the testing and Repair of the hard disk drive, Firmware, BIOS and or hardware components. This utility repairs security descriptors, files, indexing, defects, bad sectors, file system integrity and other items integral to the proper operation of the hard disk drive and or hardware. This step in the Process is imperative to ensuring the stability of the hard disk, data and hardware prior to subsequent extensive file checks and Repairs.

FIG. 1 (5) illustrates restoring of missing and or corrupt system files, data and settings in or controlled by the operating system or computer control software. This is done only after the hard disks integrity has been established to limit potential damage. This process step can restore previous successful states repairing or removing bad software installations, corrupted drivers, missing DLL's or components, hung or corrupted programs, Threats that are disabling the computer, software or Operating System, and a multitude of low level repair or restoration operations designed to get the computer running again.

FIG. 1 (6) illustrates the running of Tools, and or software that removes file level Threats. RootKits and Worms are examples of file level Threats that attach themselves, create or otherwise modify individual files and folders and/or otherwise modify names, extensions or the execution of code at the file level. Start-up of the computer in a different Operating System or control code renders these Threats inoperable exposing them for easy removal.

FIG. 1 (7) illustrates downloading of code, software, programs, Tools and/or instructions to execute and provide control of the computers Operating System located on the hard disk drive for the purpose of automatically launching, sequencing, monitoring, and closing, software, programs, instructions and tools. This code allows the program to work within the computers Operating System to further initiate Repairs. In addition data is passed summarizing run times, effectiveness, boot success, test results, software and hardware inventories, driver status, machine status, registry status and settings, and various additional status or information.

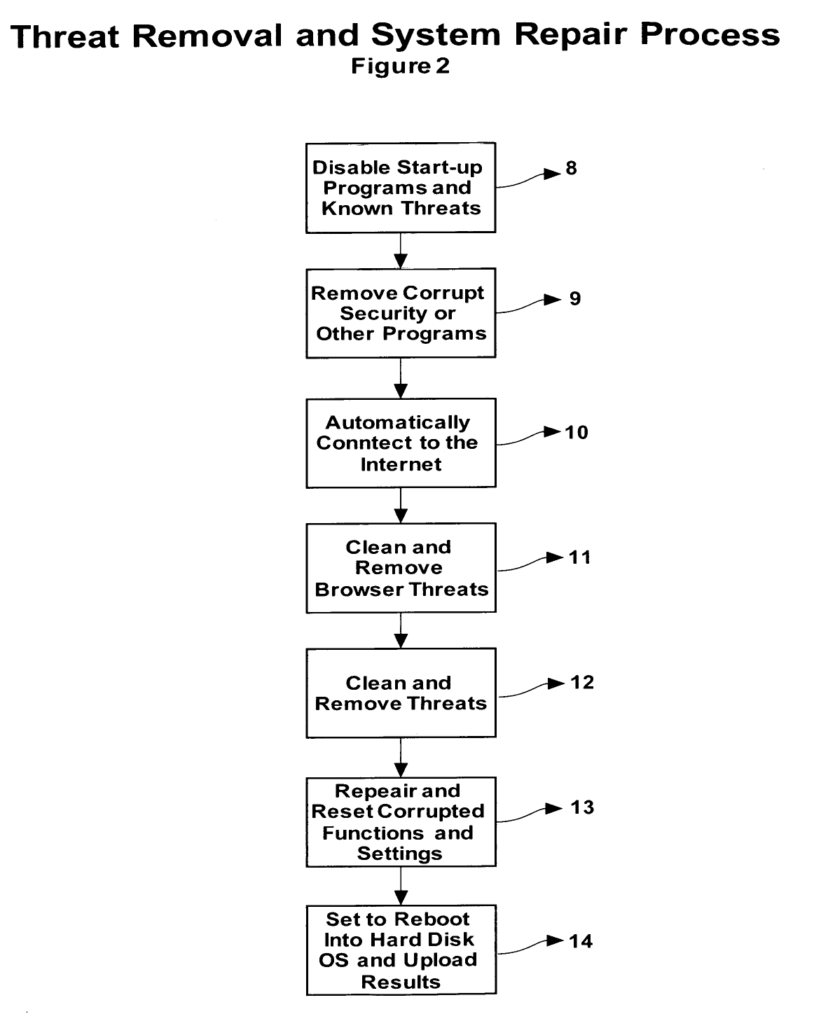

FIG. 2 represents the embodiment of a Threat Removal and System Repair Process or Step 2 as represented to perform Threat disabling, the removal and cleaning or isolation of Threats or potential Threats, and the Repair and/or resetting of operational settings or user preference settings. This process cleans and removes Threats and resets and or repairs the disabled computer to the operational state prior to the corruption caused by the Threats.

FIG. 2 (8) illustrates the execution of software and/or Tools comprised of code, programs, processes, executables, commands, and/or other control methods to kill, disable, stop, block the launch or start up of known or suspected Threats, processes, services, executables, code execution, files, DLL's, Drivers or other malicious operations or code hereto within called “Disablers”. These Tools or software essentially kill or stop the execution of the Disablers so that Threat removal products can operate freely. The types of and methods to deploy both the Threats and their Disabling are not limited.

FIG. 2 (9) illustrates an automated process to remove corrupt or compromised security programs and/or software and other programs that are locking up or slowing down the computer. The specific algorithm utilizes a multitude of removal Tools or software in a complex and sequenced process that cleans the maximum amount of software remnants from folders, files, registry, services, processes and other stored locations here for not defined specifically due to the multitude of variables and locations on the hard disk drive.

FIG. 2 (10) represents an automated internet connectivity algorithm.

FIG. 2 (11) illustrates the execution of software, program, executable, instruction, command, tool, utility or instructions that cleans Threats, deletes temporary internet files, files, folders and resets the browser or internet access applications to original state before compromised.

FIG. 2 (12) illustrates the execution of software, program, executable, instruction, command, tool, utility or instructions that perform removal of Threats. A multitude of scanners with a multitude of functionality are used for this. One embodiment may be a file type scanner while another may be a holistic or internet based scanner. Scanner types and tools used will be dictated by effectiveness and can be interchanged easily to match current Threat removal products and Tools or to utilize emerging Threat or computer repair technologies.

FIG. 2 (13) illustrates the execution of software, program, executable, instruction, command, Tool, utility or instructions that perform repair and reset of the operating system or control programs features, files, permissions, defaults, settings, states or other pertinent settings to the proper operation of the computer that was corrupted or compromised due to the running or presence of or the removal of Threats.

FIG. 2 (14) illustrates the completion of testing and subsequent automated restart to the operating system located on the hard disk drive. Test, computer settings or state, results, and other information and data are passed to the server.

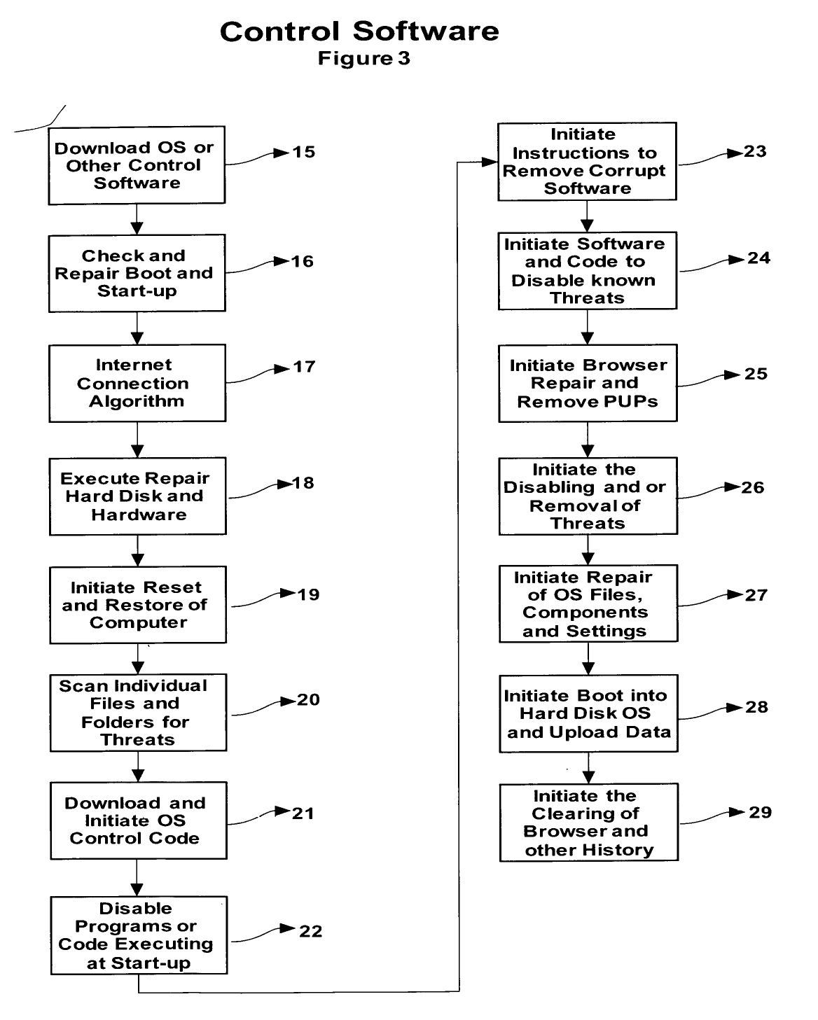

FIG. 3 illustrates one representation of Control Software that performs total PC repair on disabled, badly infected and slow computers. This software automates keystrokes or input making usage of multiple third party software, Tools and programs transparent to the end user. Along with user automation the software is easily configurable as it can download, change operational position, sequence, count, make run decisions, collect and interpret data, collect and pass to the server data, execute Tools based on conditions, provide timeouts, determines need to rerun Tools and utilities, auto boots and/or restarts during the process, provides recovery ability should problems arise and is adaptable to any and all Tools, software or methods developed in the future. It comprises use of an independent Operating System or other computer control software to start up a disabled computer allowing file access and the ability to execute and control the function of Tools, utilities, software packages and instructions. This software controls the start-up and boot of the computer and automatically provides low level Repairs, system level Repairs, boot/start-up Repairs, Operating System Repairs, software Repairs, non-defective hardware Repairs, file Repairs, software component Repairs, Threat Disabling, Threat removal and or containment, and any other problem a utility, tool or software can be developed to do as future Tools can be easily integrated into the Control Software.

FIG. 3 (15) Represents downloading an operating system or independent control code or software that allows start up and execution of code, programs, commands, executables, Tools and software independent of the computers Operating System on the hard disk drive. In addition, programs, software, instructions or other executable code is downloaded to control looping, starting, tracking, booting, restoring to original state, automation of tools, software and code, and other control features demeaned necessary in the future to Repair a computer.

FIG. 3 (16) Represents the execution of software, code, instructions, commands, executables, Tools, or other files or programs that check the boot and/or start up status of a computer and saves the data on previous states, successful boot up, registry settings, files, conditions, software states and other successful start up data. It checks and saves boot tables, boot files, MBR's, GPT, EBR, files, firmware, components, UEFI boot, BIOS settings, Bootstrap code, Boot loader, Boot ini, VBR, Boot Manager, Partition, recovery or other records, Boot Sector, Net loader, Boot Recovery Mode or other settings, code or executables related to the start up of an operating system. The program and/or code will perform an algorithm to do multitude of checks and Repairs that will allow the computer to boot successfully after completion. In addition, the software will also utilize this data to fix or Repair boot and start up and/or use it to recover the computer to the initial state prior to the customer running the software providing a recovery option if the software fails.

FIG. 3 (17) Represents the execution of software, code, instructions, commands, executables, Tools, or other files or programs that automatically determines the correct driver or control software for both wireless and Ethernet or wired connections. An algorithm will perform a multitude of connectivity options based on stored internet profiles and other data. This algorithm will check and reset the connection and reset the Ethernet or Wireless hardware in a controlled sequence that will allow successful connection in a multitude of environments. A multitude of commands, operations, resets, restarts, software, executable s or other instructions may be used in a multitude of combinations.

FIG. 3 (18) Represents the execution of software, code, instructions, commands, executables, Tools, or other files or programs that tests and Repairs a hard drive and or hardware file structure, software, firmware, BIOS, boot files, drivers, ability to access data, defects, bad sectors, descriptors, security identifiers, header or sector structure and a multitude of other hard disk and or hardware problems that may arise in the future.

FIG. 3 (19) Represents the execution of software, code, instructions, commands, executables, Tools, or other files or programs that resets the computer to a known good state, Repairs missing and/or corrupt files, folders and components, repairs the hard disk operating system or control software, software, drivers and other code, instructions or executable files.

FIG. 3 (20) Represents the execution of software, code, instructions, commands, executables, Tools, or other files or programs that perform low level scanning of files, folders, executables, code, settings, states and more to evaluate and Repair rootkits, file worms, and Threats of all and any type created in the future. The software and/or program can run multiple tools, software, executables, instructions or other operations determined necessary due to evolving Threat technologies. Software and/or program may run multiple programs or Tools singularly or in multiples. The software can loop or return to run certain programs, software, code, executables or other tasks multiple times.

FIG. 3 (21) Represents the execution of software, code, instructions, commands, executables, Tools, or other files or programs to control the reboot and operation of the computer into the operating system on the hard disk. This reboot will be done in engineering and or safe mode or similar to utilize a reduced set of instructions and commands facilitating additional Repairs. Also the user will be given an opportunity to restart the computer and continue on to the Threat Removal and System Level Repairs or step 2 as represented herein or to exit and run the step at a later time.

FIG. 3 (22) Represents the execution of software, code, instructions, commands, executables, Tools, or other files or programs that will control the start-up and restrict the launch of Disablers and or disabling software, Threats or Tools that hook or pin themselves to the start-up of the computer. Restricting or stopping the launch of Disablers reduces the control Threats have on the computer allowing for easier removal of the Threats themselves.

FIG. 3 (23) Represents the execution of software, code, instructions, commands, executables, Tools, or other files or programs that removes corrupt or compromised software, code, instructions, executable or other programs that have been installed on the hard disk drive. These corrupt programs slow and disable the computer and removal is necessary for the computers optimum operation. The software and or third party software or Tools will issue commands, execute code, run programs and mimic keystrokes to automate removal for the user.

FIG. 3 (24) Represents the execution of software, code, instructions, commands, executables, Tools, or other files or programs to remove, or disable or render ineffective, known Threats that have already affected services, processes, executables, files, programs, start-up, scheduling, the loading or execution of any file, DLL or system components or restricted the execution of code or software on the computer.

FIG. 3 (25) Represents the execution of software, code, instructions, commands, executables, Tools, or other files or programs that remove and clean internet browsers or internet access software of Threats. This program will remove PUPs, Threats, Unwanted Toolbars or browser attachments or enhancers, Adware or marketing tracking programs, software, hijackers or programs, code, instructions that take over the control of an internet browser or internet access software and any and all Threat technology that may evolve in the future.

FIG. 3 (26) Represents the execution of software, code, instructions, commands, executables, Tools, or other files or programs that renders harmless or removes Threats. These programs, software, code, instructions, commands, executables or files can vary in both abilities and scanning methods to include any Threat removal technologies not yet discovered.

FIG. 3 (27) Represents the execution of software, code, instructions, commands, executables, Tools, or other files or programs Repairs or resets Operating System or control program problems, Registry Errors and settings, Permissions problems, Browser problems, Internet Connection problems, Update issues, Firewall settings and problems, user settings and permissions, and any other functionality or setting resets or Repairs that may be developed as part of technological advancements to the Operational environments, software or Operating or control software of the computer.

FIG. 3 (28) Represents the controlled booting of the computer into the Operating System stored on the hard disk into its normal state. Prior to booting the program will upload to the server test data, successful test information, timing, log files, removal files, run information and any other data or information deemed necessary to facilitate improving the product and helping the end user understand or perform additional repairs or instruction.

FIG. 3 (29) Represents the execution of software, code, instructions, commands, executables, Tools, or other files or programs to reset or clear browsing or internet access history, temporary folders or stores, or other history, files, executables, code or commands that Threats may reside in or change the operation of to include emerging threat technologies or operations.

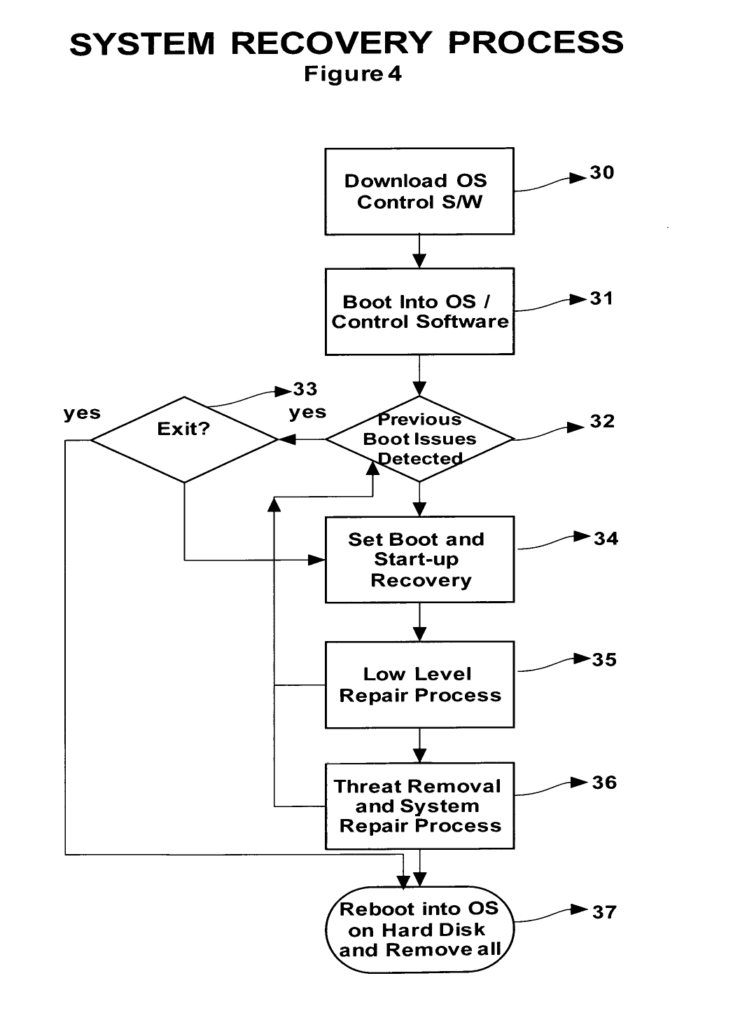

FIG. 4 Represents software, instructions, code, programs, executables, Tools, algorithms, algorithms defined here in, or other methods to store, recover, interpret and reuse information for boot and start-up, computer states, software and Operating System settings and or files and components, profiles, and or other critical information as to the state and operation of the computer before using the software. If during or after testing the software detects the computer did not boot correctly the algorithm will restore or reset the computer to the state it was in prior to running the software if the user requests. Thus repairing any damage the software or programs may have created.

FIG. 4 (30) illustrates the downloading of an operating system or control software to control the CPU independently and apart from the computers standard operating system located on its hard disk drive. This may also be other control software, instructions or other program designed to run the computer. This provides the software with independent access to files and folders in which information and data may be collected for further usage.

FIG. 4 (31) illustrates the booting or start-up of the computer into the controlled environment allowing access to files, folders, states, programs, executables, services, processes, scheduling, and other pertinent computer information or data.

FIG. 4 (32) illustrates the checking of previously stored information, states, environments, settings, boot, start-up, controls, etc. that represent all of a computers Operating System or control software, Machine conditions and states, saved parameters, saved conditions, or other information stored on the hard disk that represent health or condition of the software, hardware, or any multitude or combination of operational data, settings or information. These checks are then run through an algorithm to determine if the computer booted, started-up or otherwise came ready. If not, then a decision is made to restore the computer.

FIG. 4 (33) illustrates a decision for the user to exit and or boot back into the hard disk Operating System, or to continue testing of the computer.

FIG. 4 (34) illustrates the operation that collected all of the previously mentioned information from the computer to enable the flag to be set to check for boot or start-up. This sets the condition for the computer to look for successful boot or start-up on subsequent reboots or re-starts.

FIG. 4 (35) illustrates the ability for any step or operation from the Low Level Repair Process to launch the algorithm depicted in FIG. 1 should successful boot or start-up not be detected.

FIG. 4 (36) illustrates the ability for any step or operation from the Threat Removal and System Repair Process to launch the algorithm depicted in FIG. 2 should boot or start-up not be detected.

FIG. 4 (37) illustrates software, code, instructions, executables or other programs to boot or start-up the computer to the original Operating System on the hard disk. This program will remove and reset all of the control functions previously enabled by the software herein. In addition, a decision will be made to initiate the System Recovery Process if the algorithm determines prior boot or start-up was not successful.

1. is a novel Process that performs Repair on disabled, badly infected and slow computers using a two step program that combines a Low Level Repair Process with a Threat Removal and System Repair Process. The software uses specific sequencing of individual Tools, Software, Programs and utilities in a defined process to optimize Repairs, Threat removal, and subsequent damage repair of components, settings, files, states, history, boot, and any and/or other critical component Repairs to facilitate proper computer operation.

2. is a automated software program that utilizes automation, redundancy, Tools, third party software and Tools, software, code, executables, instructions, data collection, keystroke automation, results interpretation, and a simple user interface to allow non-technical end users the ability to effect repairs on their own computers without having complex process or computer Repair skill sets.

3. is a program to collect and interpret with an algorithm saved computer information in regards to successful boot or start-up information, states, conditions, settings and relevant data to be used in an algorithm allowing recovery of these successful boot and/or start-up conditions to effect boot or start-up repairs.

4. is a program that detects and saves computer start-up, boot, conditions, settings, states and other relevant computer information to allow a user to restore their computer should problems arise during repairs. The program automatically detects unsuccessful boot or start-up and query's the user to effect Repairs if they so choose.

5. is a program, software, utility, and/or Tool that disables or turns off Threats prior to and or shortly after Operating and or control software is launched on start-up of the computer. The program will automatically disable, turn off and/or render harmless the Threats in various ways each dedicated to specific Threat types. The combination of the methods used is too large to list and is continuously changing.
